(19) United States
(12) Patent Application Publication
(10) Pub. No.: US 2008/0124072 A1
(43) Pub. Date: May 29, 2008

(54) ELECTRIC SHUTTER WITH ELECTROCHROMIC LAYER AND CAMERA HAVING SAME

(75) Inventor: KUN-I YUAN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/831,924

(22) Filed: Jul. 31, 2007

(30) Foreign Application Priority Data
Nov. 24, 2006 (CN) 200610157065.2

(51) Int. Cl. G02F 1/00

(52) U.S. Cl. 396/457

(57) ABSTRACT

An exemplary electric shutter comprising a first transparent electrode, an electrochromic layer and a second transparent electrode, wherein said electrochromic layer is disposed between said first transparent electrode and said second transparent electrode, and said second transparent electrode has an opposite polarity to said first transparent electrode. An exemplary camera having such an electric shutter is also provided.

### BACKGROUND

1. Technical Field

The present invention relates generally to the field of imaging, and more particularly, to an electric shutter with an electrochromic layer and a camera having the same.

2. Description of the Related Art

A shutter is an essential device in a camera for controlling light exposure time during imaging. A typical shutter is constructed and operated mechanically, in which a number of pieces of metal or plastic are mechanically moved to block or allow light transmission. In order to actuate the pieces of metal or plastic, mechanical elements such as motors and gears are often incorporated in the shutter.

Cameras with such mechanical shutters suffer from a series of disadvantages. The inclusion of mechanical elements such as motor and gears often leads to difficulty in miniaturization of such cameras. In addition, the complexity of such mechanical shutters often incurs reliability issues for the shutters and the cameras incorporating them.

Therefore, what is needed is to provide a compact shutter and a camera having the same that is easy to miniaturize and able to work reliably.

### SUMMARY OF THE INVENTION

An electric shutter, in accordance with a preferred embodiment, is provided. The electric shutter includes a first transparent electrode, an electrochromic layer and a second transparent electrode. The electrochromic layer is disposed between the first transparent electrode and the second transparent electrode, and the second transparent electrode has an opposite polarity to the first transparent electrode.

A camera, in accordance with another preferred embodiment, is provided. The camera includes a lens module, an imaging element for sensing light incident thereon, and an electric shutter disposed between the lens module and the imaging element. The electric shutter includes a first transparent electrode, an electrochromic layer and a second transparent electrode. The electrochromic layer is disposed between the first transparent electrode and the second transparent electrode. The second transparent electrode has an opposite polarity to the first transparent electrode.

A camera in accordance with further another preferred embodiment is provided. The camera includes a lens module, an imaging element for sensing light incident thereon, and an electric shutter. The lens module includes a lens. The electric shutter includes a first transparent electrode, an electrochromic layer and a second transparent electrode. The electrochromic layer is disposed between the first transparent electrode and the second transparent electrode. The second transparent electrode has an opposite polarity to the first transparent electrode. The electric shutter is disposed on a surface of the lens by sequentially forming the first transparent electrode, the electrochromic layer and the second transparent electrode on the surface of the lens.

In the above-mentioned preferred embodiments, by electrically controlling the transmittance of the electric shutter and thereby electrically controlling the light exposure time of the camera, the necessity of incorporating mechanical components such as motors and gears into the shutter is eliminated. This compact design eases the difficulty of miniaturizing the camera and improves its reliability.

Other advantages and novel features will become more apparent from the following detailed description of embodiments when taken in conjunction with the accompanying drawings.

### BRIEF DESCRIPTION OF THE DRAWINGS

Many aspects of the present electric shutter and camera can be better understood with reference to the following drawings. The components in the drawings are not necessarily drawn to scale, the emphasis instead being placed upon clearly illustrating the principles of the present electric shutter and camera.

FIG. 1 is a schematic cross-sectional view of an electric shutter in accordance with a first preferred embodiment;

FIG. 2 is a schematic cross-sectional view of a camera having an electric shutter as shown in FIG. 1 in accordance with a second preferred embodiment;

FIG. 3 is a schematic cross-sectional view of a camera having an electric shutter as shown in FIG. 1 in accordance with a third preferred embodiment.

### DETAILED DESCRIPTION OF THE INVENTION

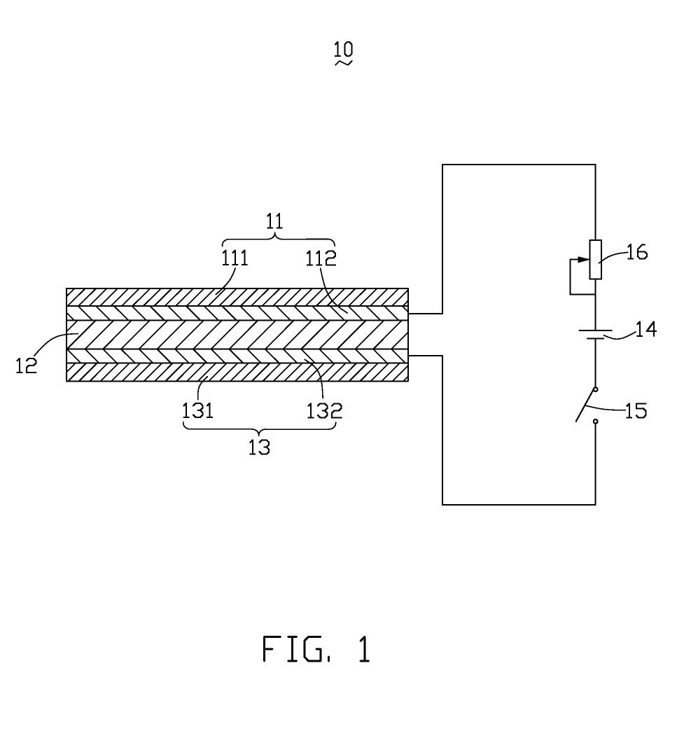

Referring to FIG. 1, an electric shutter 10, in accordance with a first preferred embodiment, is provided. The electric shutter 10 includes a first transparent electrode 11, a second transparent electrode 13 opposing the first transparent electrode 11, and an electrochromic layer 12 disposed between the first transparent electrode 11 and the second transparent electrode 13. The second transparent electrode 13 has an opposite polarity to the first transparent electrode 11. For example, if the first transparent electrode 11 is an anode, the second transparent electrode 13 is correspondingly a cathode, and vice-versa.

A control circuit is connected to the first transparent electrode 11 and the second transparent electrode 13. The control circuit includes a power source 14, a switch 15 and an adjusting element 16. The power source 14 provides a voltage between the first transparent electrode 11 and the second transparent electrode 13, forming an electric field therebetween. The switch 15 is normally turned on (connecting state) and the light exposure time can be controlled by the time for which the switch 15 is turned off (disconnecting state). The adjusting element 16 is configured for adjusting the voltage between the first transparent electrode 11 and the second transparent electrode 13 in calibration.

The first transparent electrode 11 is formed generally by depositing a transparent conductive thin film 112 on a transparent substrate 111. The second transparent electrode 13 is formed generally by depositing a transparent conductive thin film 132 on a transparent substrate 131. The transparent conductive thin film 112 or 132 can be a film made of indium tin oxide (ITO). Preferably, the transparent conductive thin films 112 and 132 contact with the electrochromic layer 12.

The electrochromic layer 12 is made of an electrochromic material selected from the group consisting of tungsten oxide (WO₃), nickel oxide (NiO), vanadium oxide (V₂O₅), and iridium oxide (IrO₂). The transmittance of the electrochromic layer varies in response to an external voltage applied thereto and the color that the electrochromic layer turns into normally depends on the material composition thereof. If multiple electrochromic materials that can transmit light of different wavelengths are combined in use in the electrochromic layer 12, the transmission of light of all the wavelengths in visible spectrum can be controlled. Preferably, the electrochromic layer 12 can be developed by mixing different electrochromic materials and forming a film of the mixture, or alternatively by superposing films of different electrochromic materials.

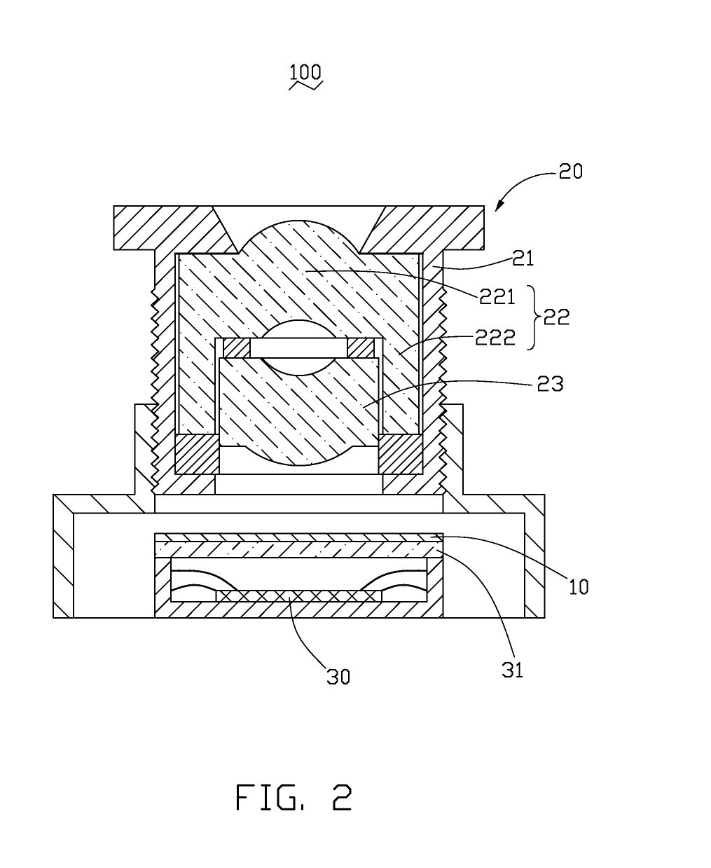

Referring to FIG. 2, a camera 100, in accordance with a second preferred embodiment, is provided. The camera 100 includes an imaging element 30, a lens module 20 and an electric shutter 10. The electric shutter 10 is the same as the electric shutter in the first preferred embodiment and disposed between the lens module 20 and the imaging element 30.

The imaging element 30 can be a CCD (charge-coupled device) or CMOS (complementary metal oxide semiconductor) image sensor, or an image film. Preferably, a transparent board 31 is disposed on a side of the imaging element 30 near to the lens module 20 for preventing dirt and dusts from contaminating the imaging element 30. To simplify the structure of camera 100, the electric shutter 10 is disposed on the transparent board 31 by sequentially forming the first transparent electrode 11, the electrochromic layer 12 and the second transparent electrode 13 on the transparent board 31. The control circuit for controlling the electric shutter 10 and a control circuit for controlling the imaging element 30 can be integrated onto a printed circuit board (not shown).

The lens module 20 includes a lens barrel 21, a lens 22, and another lens 23. The lenses 22 and 23 are sequentially arranged in the lens barrel 21 along a direction oriented from an object side to an image side of the lens module 20. The lens 22 includes an optical part 221, which optically contributes to imaging and a non-optical part 222, which does not optically contribute to imaging.

It is understandable that if the imaging element is a semiconductor image sensor, the electric shutter 10 can be disposed on a surface of the imaging element 30 facing toward the lens module 20 by sequentially forming the first transparent electrode 11, the electrochromic layer 12 and the second transparent electrode 13 thereon.

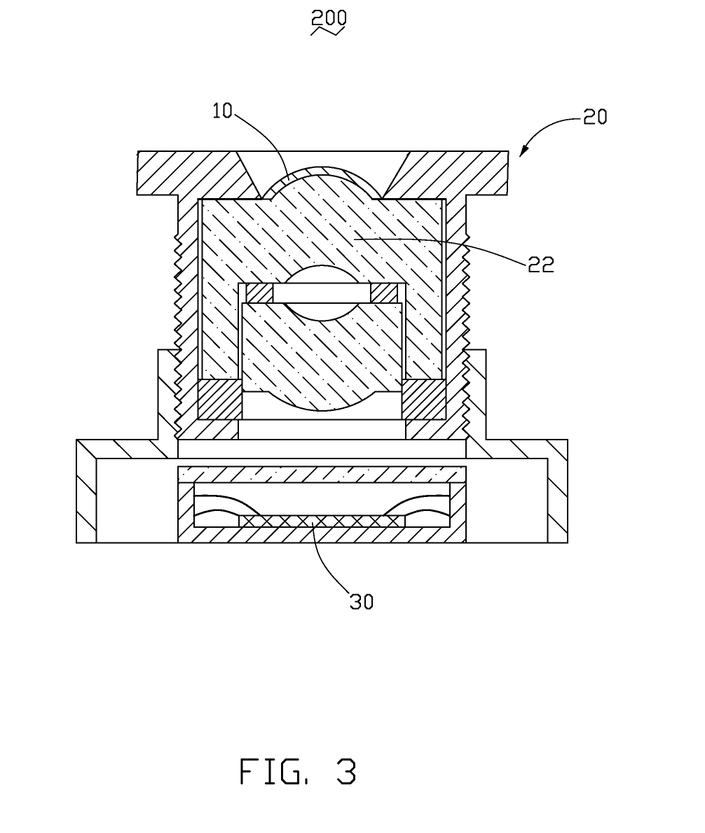

Referring to FIG. 3, a camera 200, in accordance with a third preferred embodiment, is provided. The camera 200 includes an imaging element 30, a lens module 20 and an electric shutter 10, similar to the camera 100 described in the second preferred embodiment. The difference of the camera 200 and the camera 100 in the second preferred embodiment is that in the camera 200, the electric shutter 10 is disposed on a surface of lens 22 by sequentially forming the first transparent electrode 11, the electrochromic layer 12 and the second transparent electrode 13 thereon. Preferably, the surface that the electric shutter 10 is disposed on faces the object side of the lens 22.

It is understandable that the electric shutter 10 can be disposed at other locations in the camera 200 between the object to be photographed and the imaging element 30, as long as the light coming from an object passes through the electric shutter 10 before it is incident on the imaging element 30 and forms an image of the object thereon.

In the above-mentioned preferred embodiments, by electrically controlling the transmittance of the electric shutter 10 and thereby electrically controlling the light exposure time of the camera 100 or 200, the necessity of incorporating mechanical components such as motors and gears into the shutter 10 is eliminated. This compact design eases the difficulty to miniaturize the camera 100 or 200 and improves its reliability.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An electric shutter, comprising:
a first transparent electrode,
a second transparent electrode,
an electrochromic layer sandwiched between the first and second transparent electrodes, and
a power supply electrically connected with the first and second transparent electrodes, wherein the second transparent electrode has an opposite polarity to the first transparent electrode.

2. The electric shutter of claim 1, wherein the first transparent electrode and the second transparent electrode each comprise a transparent substrate and a transparent conductive thin film formed thereon.

3. The electric shutter of claim 2, wherein the transparent conductive thin film is composed of indium tin oxide.

4. The electric shutter of claim 1, wherein the electrochromic layer is composed of an electrochromic material selected from the group consisting of tungsten oxide (WO₃), nickel oxide (NiO), vanadium oxide (V₂O₅), and iridium oxide (IrO₂).

5. The electric shutter of claim 1, wherein the electrochromic layer comprises a plurality of electrochromic materials for respectively transmitting light of different wavelengths.

6. A camera, comprising:
a lens module;
an image sensor for sensing light incident thereon; and
an electric shutter disposed between the lens module and the image sensor, the electric shutter comprising a first transparent electrode, a second transparent electrode, an electrochromic layer disposed therebetween, and a power supply electrically connected with the first and second transparent electrodes, the second transparent electrode having an opposite polarity to the first transparent electrode.

7. The camera of claim 6, further comprising a transparent board disposed between the image sensor and the lens module.

8. The camera of claim 7, wherein the electric shutter is attached to the transparent board.

9. The camera of claim 6, wherein the electric shutter is disposed on a surface of the image sensor facing toward the lens module.

10. A camera, comprising:
a lens module including at least a lens;
an image sensor for sensing light incident thereon; and
an electric shutter comprising a first transparent electrode, a second transparent electrode, an electrochromic layer interposed therebetween, and a power supply electrically connected with the first and second transparent electrodes, the second transparent electrode having an opposite polarity to the first transparent electrode, the electric shutter being disposed on a surface of the at least a lens.
